(19) United States
(12) Patent Application Publication
(10) Pub. No.: US 2013/0111126 A1
(43) Pub. Date: May 2, 2013

(54) EXPANDER TO ENABLE VIRTUAL STORAGE UNITS CORRESPONDING TO SUBDIVISIONS WITHIN A PHYSICAL STORAGE UNIT

(71) Applicants: Michael G. MYRAH, Cypress, TX (US); Balaji Natrajan, Spring, TX (US); Paul Miller, Houston, TX (US)

(72) Inventors: Michael G. MYRAH, Cypress, TX (US); Balaji Natrajan, Spring, TX (US); Paul Miller, Houston, TX (US)

(21) Appl. No.: 13/284,581

(22) Filed: Oct. 28, 2011

(51) Int. Cl. G06F 12/08

(52) U.S. Cl. 711/114; 711/E12.019

(57) ABSTRACT

In at least some embodiments, an expander includes control logic to manage temporary connections and resource allocation between a storage access request initiator and a plurality of physical storage units, and to enable virtual storage units corresponding to subdivisions within at least one of the physical storage units by emulating a PHY layer for each virtual storage unit.

### BACKGROUND

Storage access systems require a communication fabric and protocol between the devices that initiate a storage access request (e.g., to read/write data) and the targeted storage device. As an example, the original Small Computer System Interface (SCSI) standard was developed in 1981 to provide a common interface that could be used across all peripheral platforms and system applications, such as Redundant Array of Independent Disks (RAID) storage. Since that time, there have been numerous generations of the parallel SCSI protocol. Each generation doubled the bandwidth of the previous one, primarily by doubling the bus clock frequency. But as the bus frequency was increased with each new generation, so did the negative impact of bus contention, signal degradation, and signal skew—slight signal delays from one wire trace to the next. After the development of Ultra320 SCSI with a bandwidth of 320 MB/s per channel, further bandwidth improvements to parallel SCSI could not occur without developing new and expensive technologies.

In 2001, the Serial Attached SCSI Working Group was founded to define the rules for exchanging information between SCSI devices using a serial attached SCSI (SAS) interconnect. SAS was later transferred to the InterNational Committee for Information Technology Standards (INCITS) T10 to become an American (ANSI) and international (ISO/IEC) standard. SAS inherits its command set from parallel SCSI, frame formats and full duplex communication from Fibre Channel, and it uses the SATA interface for compatibility and investment protection. The SAS architecture solves the parallel SCSI problems of bus contention, clock skew, and signal degradation at higher signaling rates, thereby providing performance headroom to meet enterprise storage needs for years to come.

In an SAS topology, the number of devices (initiators, targets, and expanders) allowed in a given domain is limited only by the size of the expander routing tables. However, managing such a large number of devices can be very complicated. Therefore, zoning was introduced into the SAS-2 standard for efficiency (traffic management) and security. With SAS-2, large physical topologies can be broken into logical groups. This grouping allows access within and between zone groups to be controlled. A group of zoning-enabled expanders that cooperate to control access between PHY layers is known as a zoned portion of a service delivery system (ZPSDS). Storage systems are generally inflexible, which is particularly problematic as storage capacity increases.

### BRIEF DESCRIPTION OF THE DRAWINGS

For a detailed description of illustrative examples, reference will now be made to the accompanying drawings in which:

FIG. 1 shows a storage access system in accordance with various examples of the disclosure;

FIG. 2 shows another storage access system in accordance with various examples of the disclosure;

FIG. 3 shows yet another storage access system in accordance with various examples of the disclosure;

FIG. 4 shows features of an expander in accordance with various examples of the disclosure;

FIG. 5 shows a method in accordance with various examples of the disclosure; and

FIG. 6 shows a computer system in accordance with various examples of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Also, the term “expander” is intended to mean a device capable of making connections between an array of endpoints. Also, the term “virtual storage unit” is intended to mean a presentation of one or more storage units having different characteristics than a related underlying physical storage unit. Also, the term “temporary connection” is intended to mean a connection that is not permanently hard-wired. Also, the term “subdivision” is intended to mean discrete portions of a component. For example, subdivisions of a physical storage unit refers to discrete portions of the physical storage unit.

### DETAILED DESCRIPTION

Embodiments of the disclosure describe a technique to subdivide a storage unit (e.g., a hard drive or a solid state drive) into two or more virtual storage units (drives). For example, the virtual drives may be represented by virtual PHY layers compatible with Serial Attached SCSI-2 (SAS-2) technology. The virtual storage units will be visible to the communication fabric of a storage access system and are capable of being zoned and discovered (e.g., in accordance with the SAS-2 specification). A translation layer is provided for each virtual storage unit so that storage access requests targeting a virtual storage unit are directed to the correct location of a subdivision within a physical drive corresponding to the virtual storage unit.

As hard disk drives (HDDs) and solid state drives (SSDs) grow in capacity, subdividing these drives into multiple virtual drives becomes more desirable. One reason for splitting a physical drive into multiple virtual drives is to allow multiple storage access request initiators (e.g., memory controllers) to share the same physical drive. For example, a 2 terabyte (TB) drive could be divided into two 1 TB virtual drives with each 1 TB virtual drive zoned to a separate initiator. By preventing initiators and the rest of the storage access fabric from knowledge about the split, the virtual drives will be discovered and used as regular drives from the initiator's perspective. Another reason to split a physical drives is for constructing a form of tiered storage access using physical drives. For instance, instead of striping logical drives across three 2 TB HDDs, the user could subdivide each 2 TB drive into two virtual drives. The first virtual drive could be 1999 GB and the second could be 1 GB. In this manner, the user could stripe logical drives across the 1 GB virtual drives whose data exists in the outer sectors of the drive (this is known as “short stroking” and provides the best performance due to less head movements). So the 1 GB virtual drives would be the high performance drives and the 1999 GB virtual drives could be used for storing data that is fetched less often (e.g., for archival purposes).

In at least some embodiments, the virtual drives disclosed herein are compatible with a SAS-2 topology having initiators, expanders, and targets (e.g., physical storage units such as hard drives or solid state drives). Although not required, the physical storage units may be grouped together into JBOD (just a bunch of disks) units. In the disclosed storage access systems, at least one expander that is part of the communication fabric between the initiators and the targets are configured to support the virtual drives, which correspond to different subdivisions within a physical storage unit or within multiple storage units. The disclosed expander is also configured to support zoning (where an initiator can only discover certain drives in the storage access system architecture) at the virtual drive level.

As drive capacities become ever larger, dividing physical drives into multiple virtual drives will become increasingly useful for storage customers. Other benefits could be had by subdividing a performance component (e.g., a SSD drive) for greatly enhanced read/write access and then spreading this single resource across multiple initiators and/or multiple RAID sets.

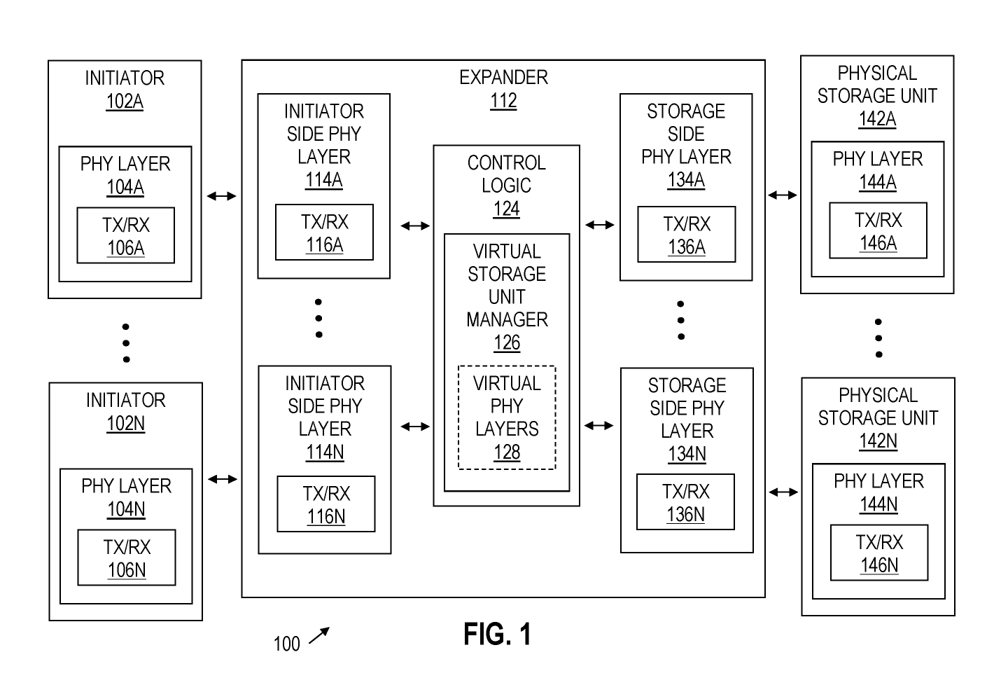

FIG. 1 shows a storage access system 100 in accordance with an embodiment of the disclosure. As shown, the storage access system 100 comprises a plurality of initiators 102A-102N in communication with a plurality of physical storage units 142A-142N via an expander 112. The initiators 102A-102N may correspond to memory controllers or another device that initiates a storage access request (e.g., to read or write data) directed to (targeting) at least one of the physical storage units 142A-142N. As shown, each of the initiators 102A-102N comprises a corresponding physical (PHY) layer 104A-104N and a transceiver (TX/RX) 106A-106N for transmitting storage access requests and receiving responses to storage access requests. Similarly, each of the physical storage units 142A-142N comprises a corresponding PHY layer 144A-144N and a transceiver (TX/RX) 146A-146N for receiving storage access requests and transmitting responses to storage access requests.

As shown, the expander 112 comprises initiator side PHY layers 114A-114N with corresponding transceivers 116A-116N and storage side PHY layers 134A-134N with corresponding transceivers 136A-136N. In accordance with at least some embodiments, the number of storage side PHY layers 134A-134N is greater than the number of initiator side PHY layers 114A-114N in order to increase flexibility regarding the number of physical storage units that are accessible by at least some of the initiators 102A-102N of the storage access system 100. In other words, the expander 112 operates to expand the number of physical storage units that are accessible to each initiator 102A-102N by supporting temporary connections between an initiator and a physical storage unit. In this manner, increased flexibility in the storage access system 100 is provided without increasing the complexity of the initiators 102A-102N nor the physical storage units 142A-142N. In at least some embodiments, the expander 112 comprises control logic 124 to manage the temporary connections between initiators 102A-102N and physical storage units 142A-142N.

To support virtual drives for the storage access system 100, the control logic 124 comprises a virtual storage unit manager 126 that maintains virtual PHY layers 128 corresponding to virtual storage units. After a virtual PHY layer 128 has been set up, storage access requests targeting the virtual PHY layer are mapped to resources of the expander 112 and to a predetermined subdivision within a physical storage unit associated with the virtual PHY layer 128. In other words, the expander 112 enables temporary connections between an initiator and subdivisions within a physical storage unit by using a virtual PHY layer for each subdivision.

Although the same variable “N” is used to describe the number of initiators, initiator side PHY layers, storage side PHY layers, and physical storage units, it should be understood that the variable “N” is intended to designate an arbitrary number. Thus, the number of initiators, the number of initiator side PHY layers, the number of storage side PHY layers, and the number of physical storage units could differ for different embodiments of the storage access system 100.

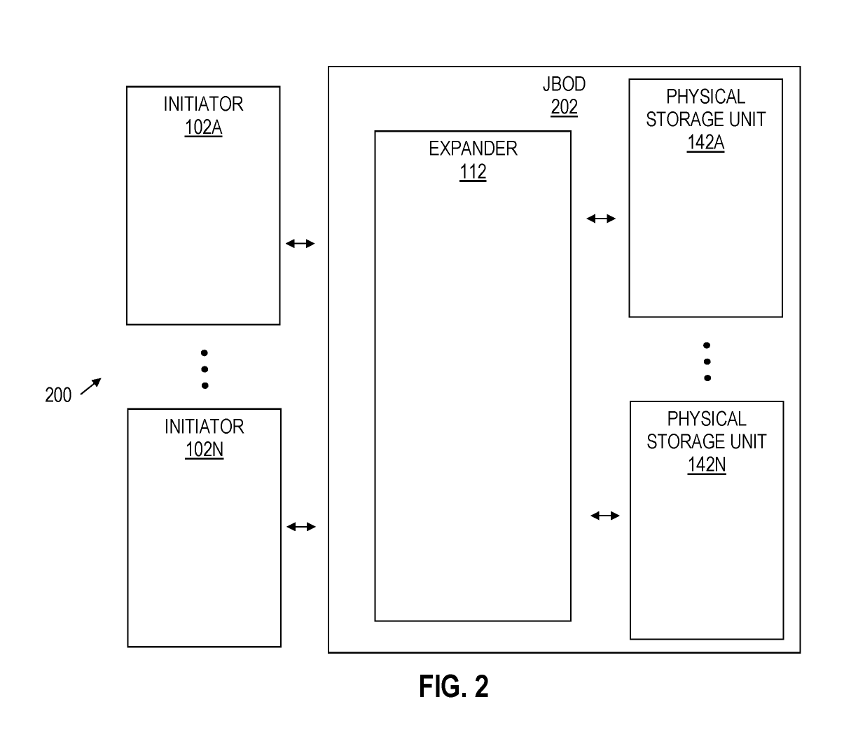

FIG. 2 shows another storage access system 200 in accordance with an embodiment of the disclosure. In the storage access system 200, the expander 112 and the physical storage units 142A-142N described for FIG. 1 are part of a JBOD unit 202. Using the virtual storage unit manager 126 described for FIG. 1, the expander 112 in FIG. 2 is able to establish temporary connections between initiators 102A-102N and virtual storage units that correspond to subdivisions within at least one of the physical storage units 142A-142N in the JBOD unit 202.

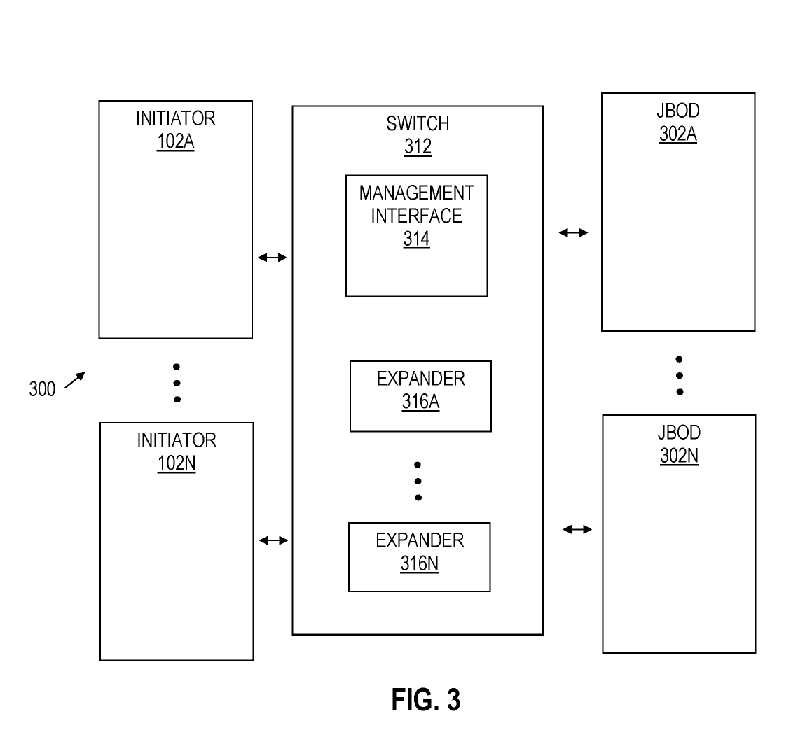

FIG. 3 shows yet another storage access system 300 in accordance with an embodiment of the disclosure. In the storage access system 300, a switch 312 having a plurality of expanders 316A-316N is positioned between initiators 102A-102N and a plurality of JBODs 302A-302N. Each of the JBODs 302A-302N in the storage access system 300 comprise a plurality of physical storage units as described for FIG. 2.

In some embodiments, at least one of the expanders 316A-316N in the switch 312 comprises a virtual storage unit manager as described for FIG. 1 to enable a temporary connection between an initiator and a subdivision within a physical storage unit in one of the JBODs 302A-302N. Additionally or alternatively, one or more of the JBODs 302A-302N may comprise an expander with a virtual storage unit manager as described for FIG. 2. In other words, there may one expander or multiple expanders in the communication fabric between an initiator and a physical storage unit. Using the virtual storage unit manager 126 described for FIG. 1, at least one expander in the switch 312 and/or the JBOD units 302A-302N is able to establish temporary connections between initiators 102A-102N and virtual storage units that correspond to subdivisions within at least one physical storage unit in the JBOD units 302A-302N.

In accordance with at least some embodiments, an expander (e.g., expander 112) in the storage access systems 100, 200, and 300 are configured to expand the number of PHY layer interfaces between initiators and physical storage units in compliance with SAS-2. Further, an expander of the storage access systems 100, 200, and 300 are configured to support zoning of the physical storage units and subdivisions within the physical storage units through the virtual storage unit technique described herein.

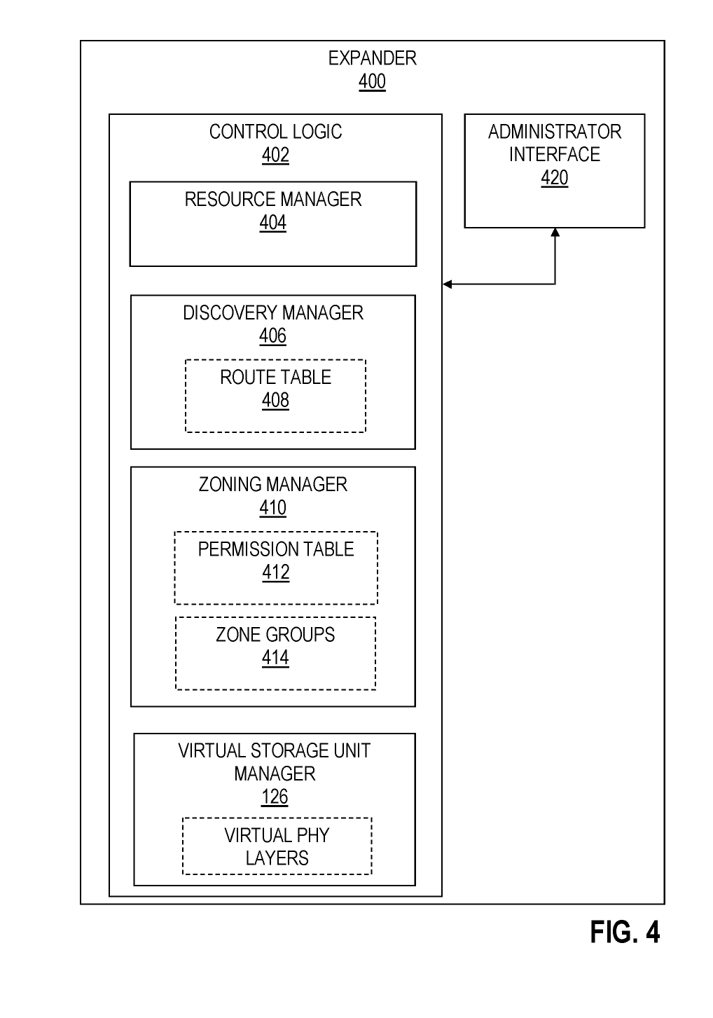

FIG. 4 shows features of an expander 400 in accordance with an embodiment of the disclosure. The expander 400 corresponds to expander 112 described in FIGS. 1 and 2, or to another expander version. In other words, different expanders may have difference features in addition to virtual storage unit management. For example, the control logic 402 of the expander 400 comprises the virtual storage unit manager 126 with virtual PHY layers 128 as described for FIG. 1. In addition, the control logic 402 comprises a resource manager 404 that, in operation, assigns communication fabric resources of the expander 400 to support temporary connections between initiators and physical storage units. During an established temporary connection between an initiator and a physical storage unit or a virtual storage unit, the resource manager 404 ensures that interruptions to the temporary (active) connection do not occur. In other words, even if multiple initiators have discovered and have permission to access a particular physical storage unit, the resource manager 404 ensures that overlapping storage access requests do not interfere with an established temporary connection. Rather, overlapping storage access requests to the same physical storage unit would be handled sequentially (e.g., in the order they are received and/or according to some other prioritization criteria).

The control logic 402 also comprises a discovery manager 406 that, in operation, performs discovery of all expanders and end devices (initiators and physical storage units) attached thereto. For example, the discovery manager 406 may perform discovery in response to an asynchronous event such as a SAS BROADCAST (CHANGE) primitive or in response to a request from a system administrator. The results of a discovery operation performed by the discovery manager 406 are stored in a route table 408. In accordance with at least some embodiments, the route table 408 stores a physical storage unit address as well as initiator addresses and expander addresses. As needed, the route table 408 is updated with each new discovery operation. Upon reception of a storage access request from an initiator, the expander 400 is able to direct the storage access request to the appropriate physical storage unit using the route table 408. Similarly, a response from the physical storage unit is routed back to the initiator using the same route table 408.

The control logic 402 also comprises a zoning manager 410 that, in operation, defines and enforces zones within a storage access system (e.g., storage access systems 100, 200, or 300). In at least some embodiments, each zone of physical storage units is only discoverable and accessible to a predetermined initiator. As shown, the zoning manager 410 comprises a permission table 412 and zone groups 414. The permission table 412 identifies which zone groups have access to other zone groups. For example, a first initiator may be assigned zone group 1 and may have access to zone groups 2 and 3, while a second initiator may be in zone group 4 and may have access to zone group 5 and so on. Further, some zone groups (e.g., zone groups 2, 3 and 5) may identify the physical storage units associated with each initiator zone group referenced in the permission table 412. In at least some embodiments, the zone groups 414 include virtual storage units corresponding to subdivisions within one or more physical storage units.

As described herein, the virtual storage units are managed by the virtual storage unit manager 126, which maintains a virtual PHY layer 128 for each virtual storage unit. In addition to maintaining the virtual PHY layers 128, the virtual storage unit manager 126 also translates a storage access request by an initiator targeting a virtual storage unit into a storage access request to a subdivision within a physical storage unit associated with the virtual storage unit.

In at least some embodiments, the virtual storage unit manager 126 supports multiple virtual storage units with different performance characteristics. For example, if a 2 TB drive may be subdivided into a first virtual drive with size 1999 GB and a second virtual drive with size 1G, the second virtual drive could correspond a high-performance drive compared to the first virtual drive. The higher performance of the 1 GB virtual drive is accomplished, for example, using the outer sections of the 2 TB drive for the 1 GB virtual drive (this is known as “short stroking” and provides the best performance due to less head movements). In different embodiments, the size and performance of the virtual storage units may vary. In some embodiments, regardless of the size and performance of the virtual storage units, the virtual storage unit manager 126 enables initiators to access the corresponding subdivisions within a physical storage unit in a manner compatible with SAS-2 technology.

In accordance with at least some embodiments, the resource manager 404, the discovery manager, 406, the zoning manager 410, and the virtual storage unit manager 126 are configured to operate together to provide expander functionality that supports virtual storage units. For example, in response to receiving a storage access request targeting a virtual storage unit from an initiator, the control logic 402 directs the resource manager 404 to allocate resources of the expander communication fabric to enable a temporary connection between the initiator and the subdivision within a physical storage unit corresponding to the virtual storage units.

Further, the virtual storage unit manager 126 may communicate with the discovery manager 406 and the zoning manager 410 to ensure that virtual storage units represented by the virtual PHY layers 128 are included as desired in the route table 406 and the zone groups 414. Further, the virtual storage unit manager 126 may be in communication with the discovery manager 406 to add at least one virtual storage unit in response to a discovery of physical storage units performed by the discovery manager 406. Additionally or alternatively, the virtual storage unit manager 126 may be in communication with the discovery manager 406 to remove at least one virtual storage unit in response to a discovery of physical storage units performed by the discovery manager 406. After a discovered physical storage unit or virtual storage unit is assigned to a zone group, then non-assigned initiators are not able to discover the physical storage unit or virtual storage unit. In some embodiments, zone assignments may be updated for discovered physical storage units and for virtual storage units in response to a control signal. The control signal is received by the expander 400, for example, via an administrator interface 420. The administrator interface 420 also may receive a control signal to designate the criteria for setting up virtual storage units. Such criteria may include the number of virtual storage units, the size of virtual storage units, the performance of virtual storage units, and the accessibility of virtual storage units (e.g., read-write or read-only).

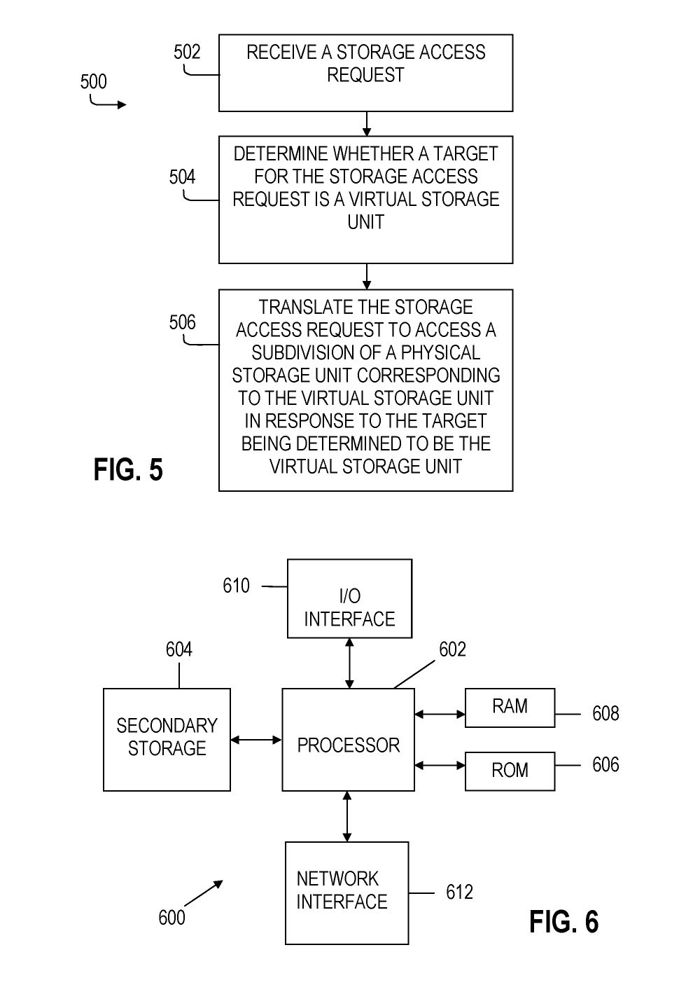

FIG. 5 shows a method 500 in accordance with an embodiment of the disclosure. The method 500 may be performed, for example, by an expander in a storage access system. As shown, the method 500 comprises receiving a storage access request (block 502) and determining whether a target for the storage access request is a virtual storage unit (block 504). At block 506, the storage access request is translated to access a subdivision within a physical storage unit corresponding to the virtual storage unit in response to the target being determined to be the virtual storage unit.

In at least some embodiments, the method 500 may additionally comprise periodically, or in response to an asynchronous event, performing a discovery process to identify a physical storage unit topology and updating a quantity of virtual storage unit based on a discovered physical storage unit topology. Additionally, the method 500 may comprise enforcing a policy that limits access to a virtual storage unit while a temporary connection to the virtual storage unit is active. Additionally, the method 500 may comprise enforcing a zoning assignment that limits discovery of a virtual storage unit to a specific storage access request initiator. Additionally, the method 500 may comprise updating the zoning assignment for a virtual storage unit. Additionally, the method 500 may comprise supporting multiple virtual storage units with different performance characteristics. Additionally, the method 500 may comprise providing a virtual PHY layer for each virtual storage unit in a manner compatible with SAS-2 technology.

The expander components and operations to support virtual storage units or drives as described above may be implemented with any general-purpose computing component, such as an application-specific integrated chip (ASIC), a computer, or a network component with sufficient processing power, memory resources, and network throughput capability to handle the necessary workload placed upon it. FIG. 6 illustrates a typical, general-purpose computer system 600 suitable for implementing one or more embodiments of the components disclosed herein. The computer system 600 includes a processor 602 (which may be referred to as a central processor unit or CPU) that is in communication with memory devices including secondary storage 604, read only memory (ROM) 606, and random access memory (RAM) 608, with an input/output (I/O) interface 610, and with a network interface 612. The processor 602 may be implemented as one or more CPU chips, or may be part of one or more application specific integrated circuits (ASICs).

The secondary storage 604 is typically comprised of one or more disk drives, flash devices, or tape drives and is used for non-volatile storage of data and as an over-flow data storage device if RAM 608 is not large enough to hold all working data. Secondary storage 604 may be used to store programs that are loaded into RAM 608 when such programs are selected for execution. The ROM 606 is used to store instructions and perhaps data that are read during program execution. ROM 606 is a non-volatile memory device that typically has a small memory capacity relative to the larger memory capacity of secondary storage 604. The RAM 608 is used to store volatile data and perhaps to store instructions. Access to both ROM 606 and RAM 608 is typically faster than to secondary storage 604.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An expander comprising:
control logic to manage connections and resource allocation between a storage access request initiator and a plurality of physical storage units, and to enable virtual storage units corresponding to subdivisions within at least one of the physical storage units by emulating a PHY layer for each virtual storage unit.

2. The expander of claim 1, wherein the control logic is to perform a discovery process to identify physical storage units coupled to the expander, and is to add at least one virtual storage unit based on a performed discovery process.

3. The expander of claim 1, wherein the control logic is to perform a discovery process to identify physical storage units coupled to the expander, and is to remove at least one virtual storage unit based on a performed discovery process.

4. The expander of claim 1, wherein the control logic is to limit access to a virtual storage unit by a first storage access request initiator while a connection established between a second storage access request initiator and the virtual storage unit is active.

5. The expander of claim 1, wherein the control logic is to maintain storage zone assignments for discovered physical storage units and for virtual storage units, where each storage zone is assigned to a specific storage access request initiator and is not discoverable by non-assigned storage access request initiators.

6. The expander of claim 1, wherein the control logic is to update storage zone assignments for virtual storage units in response to a control signal.

7. The expander of claim 1, wherein the control logic is to translate a storage access request targeting a virtual storage unit into a storage access request to a subdivision within a physical storage unit associated with the targeted virtual storage unit.

8. The expander of claim 1, wherein the control logic is to support multiple virtual storage units with different performance characteristics.

9. The expander of claim 1, wherein the control logic is to handle storage access requests targeting a virtual storage unit corresponding to subdivisions within at least one of the physical storage units in a manner compatible with Serial Attached SCSI-2 (SAS-2) technology.

10. A method comprising:
receiving, by an expander, a storage access request;
determining, by the expander, whether a target for the storage access request is a virtual storage unit; and
translating, by the expander, the storage access request to access a subdivision within a physical storage unit corresponding to the virtual storage unit in response to the target being determined to be the virtual storage unit.

11. The method of claim 10 further comprising performing a discovery process to identify a physical storage unit topology and updating a list of virtual storage units based on a discovered physical storage unit topology.

12. The method of claim 10 further comprising enforcing a policy that limits access to a virtual storage unit while a connection to the virtual storage unit is active.

13. The method of claim 10 further comprising enforcing a zoning assignment that limits discovery of a virtual storage unit to a specific storage access request initiator.

14. The method of claim 13 further comprising updating the zoning assignment for a virtual storage unit.

15. The method of claim 10 further comprising supporting multiple virtual storage units with different performance characteristics.

16. The method of claim 10 further comprising providing a virtual PHY layer for each virtual storage unit in a manner compatible with Serial Attached SCSI-2 (SAS-2) technology.

17. An apparatus comprising:
an expander to manage communications between a storage access request initiator and a plurality of physical storage units, and to manage communications between the storage access request initiator and a plurality of virtual storage units corresponding to subdivisions within at least one of the storage units.

18. The apparatus of claim 17, wherein the apparatus corresponds to a just-a-bunch-of-drives (JBOD) unit that houses the expander and the plurality of physical storage units.

19. The apparatus of claim 17, wherein the apparatus corresponds to a switch that expands a number of Serial Attached SCSI-2 (SAS-2) PHY layer interfaces between the storage access request initiator and at least one just-a-bunch-of-drives (JBOD) unit that houses the plurality of physical storage units.

20. The apparatus of claim 17, wherein the expander enforces zoning for the plurality of virtual storage unit in a manner compatible with Serial Attached SCSI-2 (SAS-2) technology.
